(19) United States
(12) Patent Application Publication
(10) Pub. No.: US 2014/0090216 A1
(43) Pub. Date: Apr. 3, 2014

(54) COMBINATION CASKET AND BURIAL VAULT

(71) Applicants: Kim Kotila, Minneapolis, MN (US); Mauri Kotila, Minneapolis, MN (US)

(72) Inventors: Kim Kotila, Minneapolis, MN (US); Mauri Kotila, Minneapolis, MN (US)

(21) Appl. No.: 13/903,968

(22) Filed: May 28, 2013

Related U.S. Application Data
(60) Provisional application No. 61/652,596, filed on May 29, 2012.

(51) Int. Cl. A61G 17/007

(52) U.S. Cl. CPC A61G 17/007
USPC 27/7; 264/279; 29/428

(57) ABSTRACT

A combination casket and burial vault for use in burying a deceased person that includes a polymeric lower casket portion and a polymeric upper casket portion. The polymeric lower casket portion is defined by an outer wall and an inner wall. The inner wall defines a recess that is adapted to receive the deceased person. The outer wall and the inner wall are attached together to define an enclosed region therebetween. An aperture extends through the outer wall. The polymeric upper casket portion is movable with respect to the polymeric lower casket portion to cover the recess.

### REFERENCE TO RELATED APPLICATION

This application claims priority to U.S. application Ser. No. 61/652,596, which was filed on May 29, 2012. The contents of which are incorporated herein by reference.

### FIELD OF THE INVENTION

The invention relates generally to caskets. More particularly, the invention relates to a combination casket and burial vault.

### BACKGROUND OF THE INVENTION

When a person passes away, it is customary in many cultures to place the person in a casket for viewing at a wake as well as for burying after a funeral. Traditionally caskets have been primarily manufactured from wood, veneer or metal that has resulted in fairly standardized casket forms. Because of the materials from which the caskets are made, the designs in which the caskets can be made are rather limited.

### SUMMARY OF THE INVENTION

An embodiment of the invention is directed to a combination casket and burial vault for use in burying a deceased person. The combination casket and burial vault includes a polymeric lower casket portion and a polymeric upper casket portion.

The polymeric lower casket portion is defined by an outer wall and an inner wall. The inner wall defines a recess that is adapted to receive the deceased person. The outer wall and the inner wall are attached together to define an enclosed region therebetween. An aperture extends through the outer wall. The polymeric upper casket portion is movable with respect to the polymeric lower casket portion to cover the recess.

Another embodiment of the invention is directed to a method of fabricating a combination casket and burial vault. The polymeric lower casket portion includes an inner wall and an outer wall. The inner wall defines a recess that is adapted to receive the deceased person. The outer wall and the inner wall are attached together to define an enclosed region therebetween. An aperture extends through the outer wall. The polymeric upper casket portion is attached to the polymeric lower casket portion.

Another embodiment of the invention is directed to a method of burying a deceased person. The polymeric lower casket portion includes an inner wall and an outer wall. The inner wall defines a recess. The outer wall and the inner wall are attached together to define an enclosed region therebetween. An aperture extends through the outer wall.

A deceased person is placed in the recess. The recess is covered with the polymeric upper casket portion to form a sealed casket. The sealed casket is buried beneath a ground surface. Water that is adjacent the sealed casket flows into the enclosed region through the aperture.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a front perspective view of a combination casket and burial vault according to an embodiment of the invention.

FIG. 2 is a back perspective view of the combination casket and burial vault of FIG. 1.

FIG. 3 is a front side view of the combination casket and burial vault of FIG. 1.

FIG. 4 is an end view of the combination casket and burial vault of FIG. 1.

FIG. 5 is an end perspective view of the combination casket and burial vault of FIG. 1.

FIG. 6 is a sectional view of the combination casket and burial vault of FIG. 1.

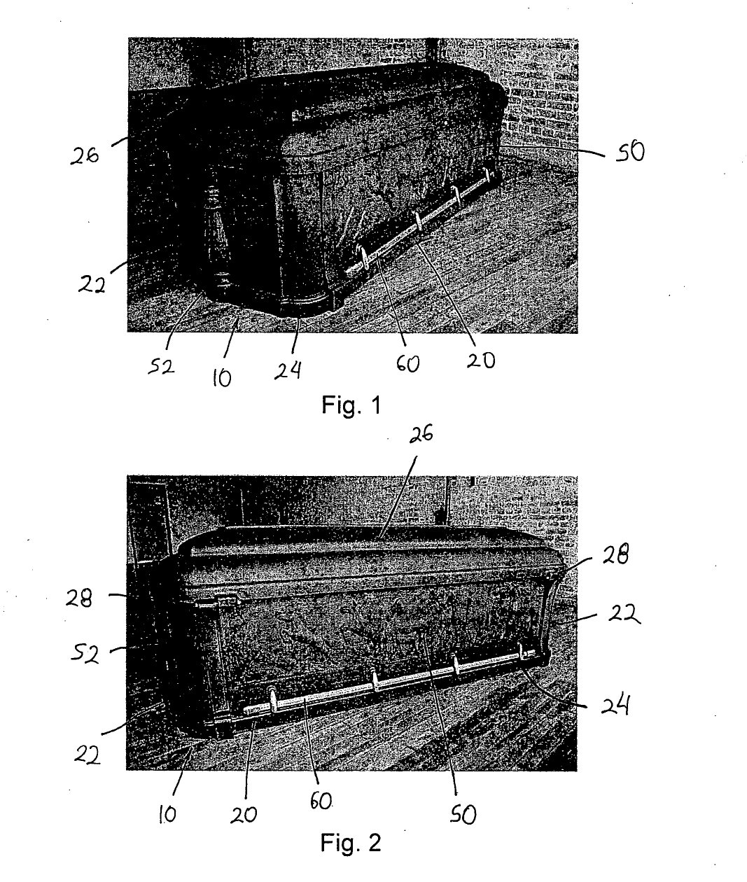

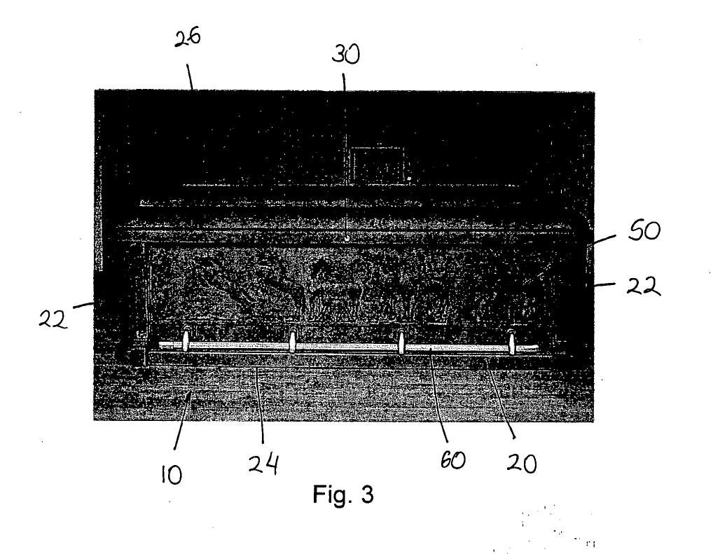

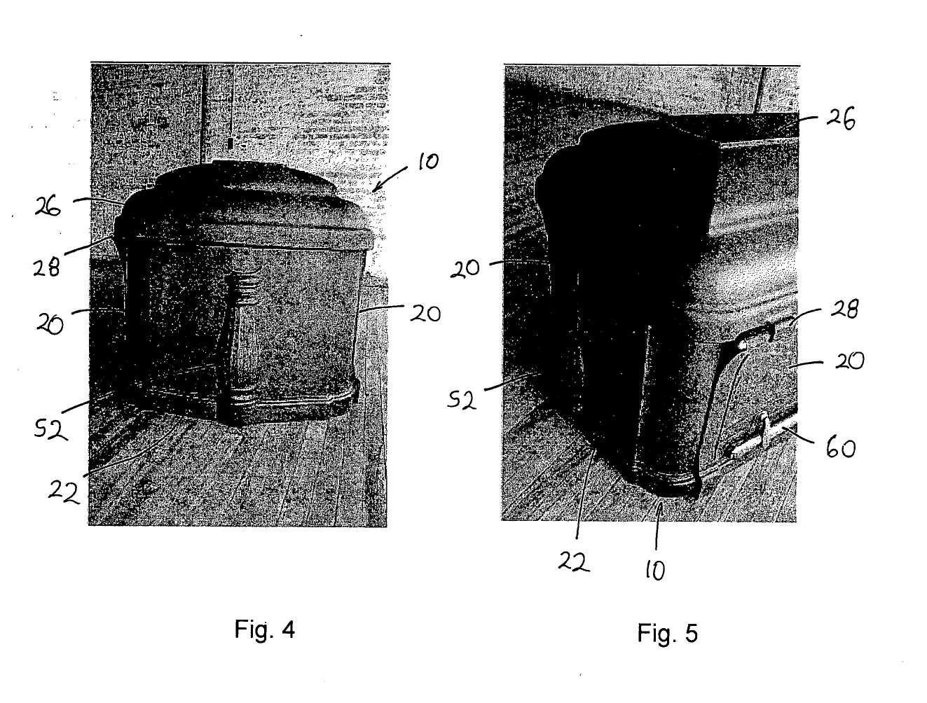

### DETAILED DESCRIPTION OF THE PREFERRED EMBODIMENTS

An embodiment of the invention is directed to a combination casket and burial vault, as illustrated at 10 in the figures. The combination casket and burial vault 10 may have a pair of side panels 20, a pair of end panels 22 and a lower panel 24 that define a lower casket region 18 that is adapted to receive the deceased person.

In one embodiment, the upper panel 26 is pivotally mounted with respect to the other portions of the combination casket and burial vault 10 such as using at least one hinge mechanism 28. The combination casket and burial vault 10 may include a locking mechanism 30 that retains the upper panel 26 in a closed configuration with respect to the other portions of the combination casket and burial vault 10.

When the invention is used during a funeral or other memorial service, the combination casket and burial vault 10 may include an attractive appearance. For example, in certain embodiments, the combination casket and burial vault 10 may be fabricated with at least one design 50 on at least one surface thereof.

In other embodiments, the at least one design 50 is formed on the side panels 20 of the combination casket and burial vault 10. It is also possible to form the at least one design 50 on at least one of the end panels 22 and the upper panel 26. A design (not shown) may also be formed on the lower surface of the upper panel 26.

The at least one design 50 may be selected to celebrate aspects of the deceased person's life. For example, the combination casket and burial vault 10 may be formed with a plurality of horses to show the deceased person's fondness for horses. It is also possible for the design to reflect aspects of the deceased person's religion.

While it is illustrated that the same at least one design 50 is formed on both of the side panels 20, it is possible for the at least one design 50 to be different on each of the side panels 20. It is also possible for more than one design 50 to be formed on the side panels 20.

To facilitate lifting and moving of the combination casket and burial vault 10, a handle 60 may be mounted to at least one of the side panels 20 and the end panels 22. In certain embodiments, the handle 60 may be pivotally mounted to the combination casket and burial vault 10. Such a configuration not only enhances the ability to grasp the handle 60 but also minimizes interference of the handle 60 such as in the memorial service.

Because the strength of conventional caskets may degrade after the casket is buried in the ground, it is customary in many locations to place the casket into a burial vault. In certain circumstances the burial vault may be fabricated from concrete, which resists degradation for a longer period of time than the casket.

The typical standard for concrete burial vaults is that the concrete burial vaults are capable of supporting a load of at least 5,000 pounds per square foot without experiencing damage.

The combination casket and burial vault 10 may be formed from a variety of materials using the concepts of the invention. One such class of materials that may be used to fabricate the combination casket and burial vault 10 are polymeric materials that are molded into a desired shape.

Forming the combination casket and burial vault 10 from the polymeric material enables the combination casket and burial vault 10 to be molded in a variety of different colors. Alternatively or additionally, at least a portion of the combination casket and burial vault 10 may be painted after the fabrication process.

The combination casket and burial vault 10 may be formed with a size that generally conforms to the size of the deceased person that is to be buried in the combination casket and burial vault 10. For example, the combination casket and burial vault 10 may be formed in three sizes that are intended for use with infants, children and adults.

In certain embodiments, the combination casket and burial vault 10 may have a height and a width that are both between about 1 feet and about 5 feet. In certain embodiments, the combination casket and burial vault 10 may have a length of between about 2 feet and about 8 feet.

Because of the size of the combination casket and burial vault 10 and the desired strength of the combination casket and burial vault 10, a suitable technique that is particularly suited for use in fabricating the combination casket and burial vault 10 is rotational molding.

The rotational molding enables the combination casket and burial vault 10 to be fabricated with outer and inner walls along with an opening between the inner wall 40 and the outer wall 42. The inner wall 40 and the outer wall 42 provide the combination casket and burial vault 10 with the strength characteristics discussed herein.

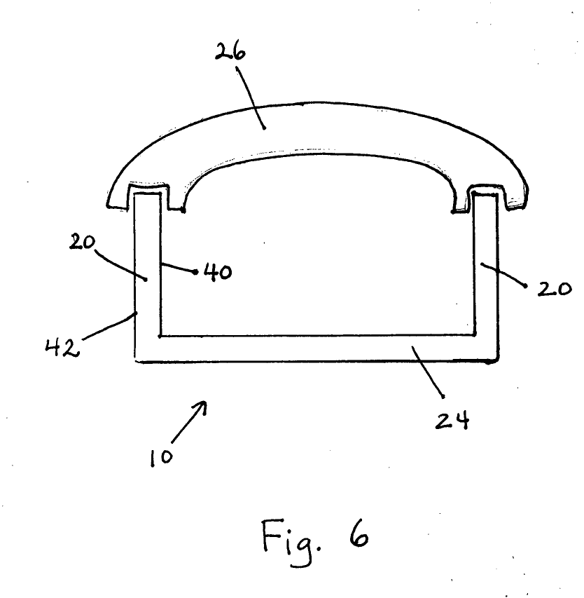

In certain embodiments, the opening is substantially enclosed, as illustrated in FIG. 6. For example, the inner wall 40 and the outer wall 42 may be interconnected along an upper edge of the lower casket region 18. The inner wall 40 defines a recess that is adapted to receive the deceased person.

While not illustrated, it is possible that at least one support member may extend between the inner wall 40 and the outer wall 42 to increase the structural rigidity of the combination casket and burial vault 10.

Each of the panels in the combination casket and burial vault 10 may have a thickness of between about 1 inch and about 6 inches. In certain embodiments, the inner wall 40 and the outer wall 42 each have a thickness of between about ¼ of an inch and about 2 inches.

Another advantage of using the molding process is that a portion of the mold may be removable so that the at least one design 50 formed on the combination casket and burial vault 10 can be readily changed by replacing only a portion of the mold. The configuration reduces the cost compared to other configurations where an entire mold be fabricated for each of the designs that are desired to be provided on the combination casket and burial vault 10.

The opening between the outer and inner walls allows the weight of the combination casket and burial vault 10 to be reduced when compared to caskets having a solid material that extends between the inner wall 40 and the outer wall 42. In certain embodiments, the combination casket and burial vault 10 has a weight of less than about 200 pounds.

Forming the combination casket and burial vault 10 with a weight in the preceding range allows the combination casket and burial vault 10 to be handled similar to conventional caskets. However, the increased strength of the combination casket and burial vault 10 enables the invention to be buried without the use of a concrete burial vault 10.

The invention thereby reduces the cost associated with the concrete burial vault 10. Additionally, because it is not necessary to dig the hole sufficiently large to accommodate the casket and the concrete burial vault 10, the hole can have smaller dimensions.

A gasket 48 may be provided to seal the upper panel 26 to the other portions of the combination casket and burial vault 10 when the upper panel 26 is in a closed configuration. In certain embodiments, the gasket 48 may substantially prevent water and/or other liquids from entering the interior of the combination casket and burial vault 10 where the deceased person is placed.

The combination casket and burial vault 10 made according to the embodiments of the invention may have a relatively low weight. Because of this relatively low weight, the combination casket and burial vault 10 may have a tendency to move upwardly towards the ground surface after being buried.

One option to increase the weight of the combination casket and burial vault 10 is to fill at least a portion of the space between the inner wall 40 and the outer wall 42 of the combination casket and burial vault 10 with a relatively dense material such as sand or concrete. While such a process increases the weight of the combination casket and burial vault 10 to reduce upward movement after burial, it also increases the weight of the combination casket and burial vault 10.

Such additional weight may increase the costs of transporting the combination casket and burial vault 10 during the distribution process. Additionally, the additional weight may present challenges for carrying the combination casket and burial vault 10 with the deceased person placed therein during the funeral process.

Accordingly, it is desirable for the combination casket and burial vault 10 to have the lowest possible weight during the distribution and funeral processes but increasing the weight of the combination casket and burial vault 10 after burial.

In certain embodiments, the outer wall 42 of the combination casket and burial vault 10 has at least one aperture 70 formed therein. The at least one aperture 70 allows water to enter a region between the inner wall 40 and the outer wall 42 after the combination casket and burial vault 10 is buried. Such water may be present in the ground surrounding the combination casket and burial vault 10.

Through the addition of the water to the region between the inner wall 40 and the outer wall 42, the overall weight of the combination casket and burial vault 10 is significantly increased, which reduces the potential of the combination casket and burial vault 10 moving towards the ground surface after burial.

The at least one aperture 70 may not extend through the inner wall 40. Using such a configuration, water is not permitted to enter the interior of the combination casket and burial vault 10 where the body is placed.

The at least one aperture 70 may include at least two lower apertures 70a. The lower apertures 70a may be formed in the lower panel 24 or proximate a lower edge of at least one of the side panels 20 or the end panels 22.

In certain embodiments, the lower apertures 70a may be provided in a spaced-apart configuration such as proximate opposite ends of the combination casket and burial vault 10. The lower apertures 70a may have a size that is up to about 1 inch. In other embodiments, the lower apertures 70a have a diameter of about ½ of an inch.

The at least one aperture 70 may also include at least two upper apertures 70b. The upper apertures 70b may be formed proximate an upper edge of at least one of the side panels 20 or the end panels 22.

In certain embodiments, the upper apertures 70b may be provided in a spaced-apart configuration such as proximate opposite ends of the combination casket and burial vault 10. The upper apertures 70b may have a size that is smaller than the lower apertures 70a. In certain embodiments, the upper apertures 70b may have a diameter of up to about 1 inch. In other embodiments, the upper apertures 70b have a diameter of about 1/16 of an inch.

While not illustrated, it is also possible to form at least one aperture in the upper panel 26 if it is desired to increase the weight of the combination casket and burial vault 10 more than is possible by filling the region between the inner wall 40 and the outer wall 42 of the lower portion of the combination casket and burial vault 10.

As an alternative to forming the at least one aperture 70 in the combination casket and burial vault 10 to allow ground water to fill the region between the inner wall 40 and the outer wall 42 of the combination casket and burial vault 10, it is possible to form at least one opening (not shown) in the combination casket and burial vault 10 through which it is possible to introduce a fluid such as water.

The opening may utilize a variety of connection mechanism such as threaded or friction fit to transfer the fluid from the delivery mechanism such as a hose. Such a technique may be used to introduce water into the combination casket and burial vault 10 either after or before burial.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. A combination casket and burial vault for use in burying a deceased person, wherein the combination casket and burial vault comprises:
a polymeric lower casket portion that is defined by an outer wall and an inner wall, wherein the inner wall defines a recess that is adapted to receive the deceased person, wherein the outer wall and the inner wall are attached together to define an enclosed region therebetween and wherein an aperture that extends through the outer wall; and
a polymeric upper casket portion that is movable with respect to the polymeric lower casket portion to cover the recess.

2. The combination casket and burial vault of claim 1, wherein the polymeric lower casket portion comprises two side panels, two end panels and a lower panel.

3. The combination casket and burial vault of claim 1, wherein the polymeric upper casket portion comprises an outer wall and an inner wall.

4. The combination casket and burial vault of claim 1, wherein when the polymeric upper casket portion is in a closed configuration with respect to the polymeric lower casket portion, the polymeric upper casket portion seals the recess.

5. The combination casket and burial vault of claim 1, and further comprising:
a hinge that pivotally attaches the polymeric upper casket portion to the polymeric lower casket portion;
a lock that is capable of retaining the polymeric upper casket portion in a closed relationship with respect to the polymeric lower casket portion; and
a handle attached to the outer wall.

6. The combination casket and burial vault of claim 1, wherein the polymeric lower casket portion further comprises a design formed on at least a portion of the outer wall and wherein the design relates to an aspect of the deceased person's life.

7. The combination casket and burial vault of claim 1, wherein the aperture comprises a lower aperture and an upper aperture.

8. The combination casket and burial vault of claim 1, wherein the aperture comprises a connection that is adapted to engage a hose for delivering a liquid to the enclosed region.

9. A method of fabricating a combination casket and burial vault comprising:
forming a polymeric lower casket portion, wherein the polymeric lower casket portion comprises an inner wall and an outer wall, wherein the inner wall defines a recess that is adapted to receive the deceased person, wherein the outer wall and the inner wall are attached together to define an enclosed region therebetween and wherein an aperture extends through the outer wall;
forming the second polymeric resin into the polymer upper casket portion; and
attaching the polymeric upper casket portion to the polymeric lower casket portion.

10. The method of claim 9, wherein the polymeric lower casket portion comprises two side panels, two end panels and a lower panel.

11. The method of claim 9, wherein the polymeric upper casket portion comprises an outer wall and an inner wall and wherein when the polymeric upper casket portion is in a closed configuration with respect to the polymeric lower casket portion, the polymeric upper casket portion seals the recess.

12. The method of claim 9, and further comprising forming a design on at least a portion of the outer wall, wherein the design relates to an aspect of the deceased person's life.

13. The method of claim 9, wherein the aperture comprises a lower aperture and an upper aperture and wherein the lower aperture has a larger size than the upper aperture.

14. The method of claim 9, and further comprising delivering a liquid to the enclosed region through the aperture.

15. A method of burying a deceased person comprising:
forming a polymeric lower casket portion, wherein the polymeric lower casket portion comprises an inner wall and an outer wall, wherein the inner wall defines a recess, wherein the outer wall and the inner wall are attached together to define an enclosed region therebetween and wherein an aperture extends through the outer wall;
placing deceased person in the recess;
covering the recess with a polymeric upper casket portion to form a sealed casket;
burying the sealed casket; and
allowing water that is adjacent the outer wall to flow into the enclosed region through the aperture.

16. The method of claim 15, wherein the sealed casket buried without being placed in a burial vault.

17. The method of claim 15, and further comprising substantially preventing water adjacent to the outer wall from entering the recess.

18. The method of claim 15, wherein the aperture comprises an upper aperture and a lower aperture in the outer wall.

19. The method of claim 15, wherein the polymeric lower casket portion is formed using rotational molding.

20. The method of claim 15, wherein forming the polymeric lower casket portion further comprises placing a mold insert within a mold that is used to form the polymeric lower casket portion and wherein the mold insert has a design formed thereon that relates to an aspect of the deceased person's life.
